(19) United States
(12) Patent Application Publication
(10) Pub. No.: US 2026/0172476 A1
(43) Pub. Date: Jun. 18, 2026

(54) GENERATING AND SHARING A VIRTUAL REALITY EXPERIENCE

(71) Applicant: INTERNATIONAL BUSINESS MACHINES CORPORATION, ARMONK, NY (US)

(72) Inventors: Aaron Keith Baughman, Cary, NC (US); Sarbajit Kumar Rakshit, Kolkata (IN); Eduardo Morales, Key Biscayne, FL (US); Rahul Agarwal, Jersey City, NJ (US)

(21) Appl. No.: 18/984,591

(22) Filed: Dec. 17, 2024

(51) Int. Cl. H04L 67/131; G06T 19/00; H04L 9/40

(52) U.S. Cl. CPC H04L 67/131; G06T 19/006; H04L 63/101

(57) ABSTRACT

Provided are techniques for generating and sharing a VR experience. Actual experience data for an actual experience of a first user performing an activity is captured. The actual experience data is analyzed to identify physical experiences and cognitive experiences. Input is received from a second user of a selection of experiences from the physical experiences and the cognitive experiences of the first user. Based on the selection, a virtual reality experience is generated. The virtual reality experience is played for the second user.

### BACKGROUND

Embodiments of the invention relate to generating a Virtual Reality (VR) experience from an actual experience and sharing that VR experience.

VR is a simulated experience that typically employs pose tracking and 3-Dimensional (3D) near-eye displays to give a user an immersive feel of a virtual world. Applications of VR include entertainment (such as video games), education (such as medical or military training), and business (such as virtual meetings). Other types of VR-style technology include augmented reality and mixed reality, sometimes referred to as extended reality or XR, although definitions are currently changing due to the nascence of the industry.

### SUMMARY

In accordance with certain embodiments, a computer-implemented method is provided for generating and sharing a VR experience. In such embodiments, actual experience data for an actual experience of a first user performing an activity is captured. The actual experience data is analyzed to identify physical experiences and cognitive experiences. Input is received from a second user of a selection of experiences from the physical experiences and the cognitive experiences of the first user. Based on the selection, a virtual reality experience is generated. The virtual reality experience is played for the second user.

In accordance with other embodiments, a computer program product comprising a computer readable storage medium having program code embodied therewith is provided, where the program code is executable by at least one computer processor to perform operations for generating and sharing a VR experience. In such embodiments, actual experience data for an actual experience of a first user performing an activity is captured. The actual experience data is analyzed to identify physical experiences and cognitive experiences. Input is received from a second user of a selection of experiences from the physical experiences and the cognitive experiences of the first user. Based on the selection, a virtual reality experience is generated. The virtual reality experience is played for the second user.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for generating and sharing a VR experience. In such embodiments, actual experience data for an actual experience of a first user performing an activity is captured. The actual experience data is analyzed to identify physical experiences and cognitive experiences. Input is received from a second user of a selection of experiences from the physical experiences and the cognitive experiences of the first user. Based on the selection, a virtual reality experience is generated. The virtual reality experience is played for the second user.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment of a VR system in accordance with certain embodiments.

FIGS. 3A and 3B illustrate, in a flowchart, operations for generating a VR experience from an actual experience in accordance with certain embodiments.

FIGS. 4A and 4B illustrate, in a flowchart, operations for generating a VR experience using machine learning models in accordance with certain embodiments.

FIG. 5 illustrates further details of operational transport in accordance with certain embodiment.

FIG. 6 illustrates, in a flowchart, operations for generating a VR experience using a deep foundational model in accordance with certain embodiments.

FIG. 7 illustrates equations used for generating the VR experience in accordance with certain embodiments.

FIG. 8 illustrates pseudocode in accordance with certain embodiments.

FIG. 9 illustrates, in a flowchart, operations for generating a Virtual Reality (VR) experience from an actual experience and sharing that VR experience in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

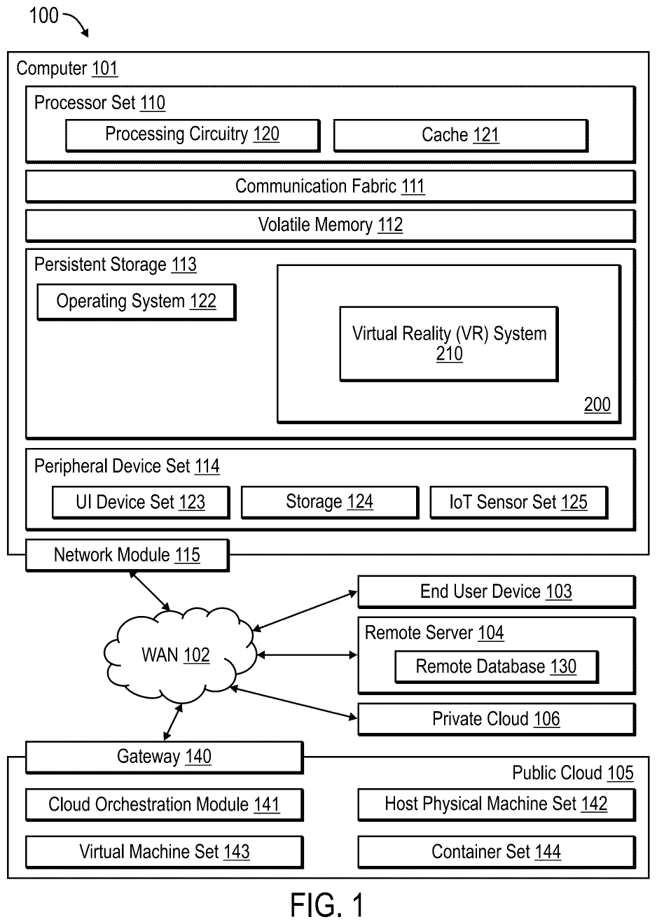

Computing environment 100 of FIG. 1 contains an example of an environment for the execution of at least some of the computer code involved in performing the inventive methods, such as Virtual Reality (VR) system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Standard VR systems use either VR headsets or multi-projected environments to generate realistic images, sounds, and other sensations that simulate a user's physical presence in a virtual environment. A person using VR equipment is able to look around the artificial world, move around in it, and interact with virtual features or items. The effect is commonly created by VR headsets consisting of a head-mounted display with a small screen in front of the eyes, but can also be created through specially designed rooms with multiple large screens. VR typically incorporates auditory and video feedback, but may also allow other types of sensory and force feedback through haptic technology.

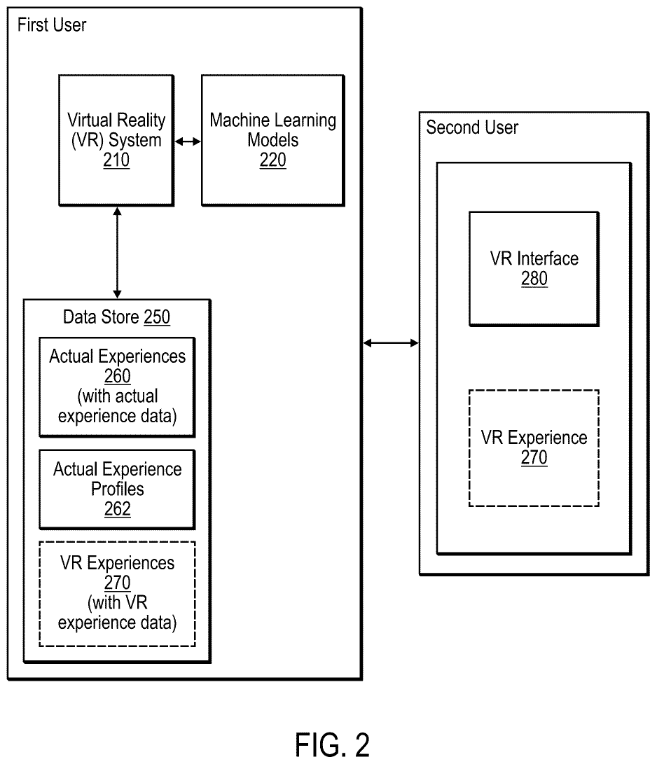

FIG. 2 illustrates a computing environment of a VR system 210 in accordance with certain embodiments. The VR system 210 is connected to machine learning models 220 and to a data store 250. The data store 250 includes actual experiences 260 with actual experience data, actual experience profiles 262, and VR experiences 270 with VR experience data.

The actual experience data of an actual experience 260 includes data collected from sensors, cameras, biometric data collectors, and other devices with sensors, cameras and/or microphones. For example, the actual experience data may be captured by Internet of Things (IoT) devices of roads and machines, wearable devices of the first user, a smart phone of the first user, and Brain Computer Interface (BCI) enabled devices. The wearable devices include VR glasses, Augmented reality (AR) glasses, and Mixed Reality (MR) glasses, a smart watch, a smart shirt, location enabled devices using technology such as Global Positioning System (GPS) and General Packet Radio Service (GPRS), blue tooth key tracker, smart shoes, smart socks, smart pants, smart belt, smart ring, smart finger, smart bracelet, and other electronics or electronic cloth-based items. The actual experience data represents a first user having an actual experience (e.g., riding a rollercoaster in real life). The actual experience data includes environment data describing the environment of the activity and biometric data of the first user.

The VR system 210 uses the actual experience data of an activity to generate an actual experience profile 262 and a VR experience 270 using one or more of the machine learning models 220.

The VR system 210 enables different users to share the VR experience 270. For example, the VR system 210 sends the VR experience 270 to a second user who views the VR experience 270 in a VR interface 280. The VR interface 280 may be a VR headset, a VR room or other device that enables playing of the VR experience 270.

In certain embodiments, the VR system 210 provides a VR experience based on teleoperations with contour sharing of actor-based experiences using context in symbiotic relationships.

Teleoperations enable exploring or actuating changes within an environment with reference to changing haptics, digital experiences or any other manifestations. Haptics use technology to simulate the sense of touch and motion.

Contours are based on the smoothing of experiences between teleoperated changes within a location to create a cohesive and consistent change. Without the smoothing there may be a potentially dichotomic before and after experience based on transitionary experiences. That is, the changes made using teleoperations may update the environment to different places, and the contours are used to provide a smooth experience and avoid a dichotomic before and after experience.

A symbiotic relationship creates a lifelike and first-person experience for the person experiencing the teleoperated environment.

For example, while travelling from one place to another place or performing any activity, a first user has an actual experience. For example, when the first user is driving on a congested road, the first user's cognitive agitation and the vehicle's movements are collected using sensors and other devices. In this example, the first user is an actor, while the vehicle is “context”. Further, if the first user (actor) is outside and experiencing particular weather (context), the first user's movements and the weather measurements are collected by sensors and other devices. The VR system 210 takes the collected data from a first user's perspective of an actual experience and generates a VR experience 270. The VR experience 270 is an augmented reality first person experience through teleoperated experiences.

In addition, the VR system 210 plays the VR experience for a second user so that the second user may teleoperationally explore the first user's actual experience. While doing this, the second user may want to move to a new location to determine whether there are better places to drive or areas to experience an outdoor event. To enable this, the VR system 210 slowly changes the augmented reality experience along the contours of other sharable experiences.

In addition, the first user may share the VR experience 270 so that the second user may also have a similar experience with the VR interface. The VR system 210 enables the first user to set limits on use of the VR experience 270 to indicate who may share the VR experience 270 and/or which portions of the VR experience 270 are shareable.

The VR system 210 captures the actual experience data of an actual experience 260 of a first user while the first user is performing an activity. An activity is an action or set of actions. For example, an activity may be, for example, travelling, driving, cooking, exercising or going on a rollercoaster. The VR system 210 captures the actual experience data from, for example, Internet of Things (IoT) devices of roads and machines, wearable devices of the first user, and other devices with sensors, cameras and/or microphones. The actual experience data identifies sharable physical and cognitive experiences of the first user while performing the activity. The VR system 210 uses the actual experience data to generate a VR experience 270 and allows the first user or a second user to replicate the sharable physical and cognitive experiences of the activity with a VR interface.

For sharing the physical and cognitive experiences of an activity, the first user may set access rights on different types of physical and cognitive experiences. The access rights may be described as permissions and may include parental control rules, rules associated with specific users or rules associated with a pre-defined group of users. The VR system 210 generates a VR experience 270 with the appropriate physical and cognitive experiences based on the access rights of the second user and plays the VR experience 270 in the VR interface.

The second user may select one or more types of shared experiences from one or more first users, and the VR system 210 generates a VR experience 270 replicating a similar level of physical and cognitive experiences.

While capturing the actual experience data of an actual experience 260, the VR system 210 analyzes the IoT and wearable feeds, performs image analysis captured by the first user and participating users for textual or verbal feedback. The VR system 210 creates an actual experience profile 262 of the user that includes activity details. In certain embodiments, the actual experience profile 262 includes the access rights.

In certain embodiments, the VR system 210 uses a deep foundational model adaptation derived from teleoperated online learning. In addition, the VR system 210 provides acceleration based batch and epoch learning. That is, the VR system 210 may use machine learning models for batch and epoch learning to improve acceleration with a VR experience. Acceleration refers to the speed at which the VR experience is played (e.g., a car going from 15 miles per hour to 25 miles per hour).

The VR system 210 selects the foundational model using optimal transport between Latent Semantic Analysis (LSA) of the teleoperational environment and the model.

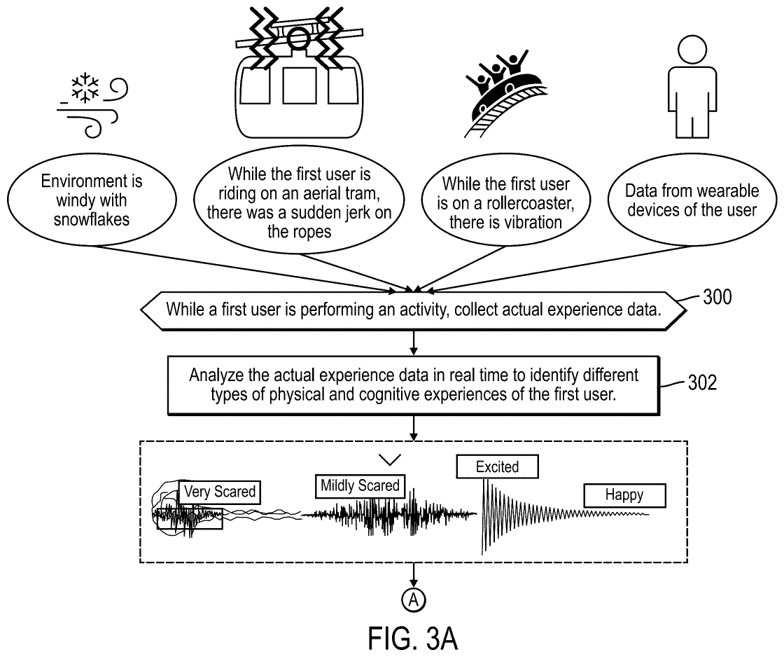

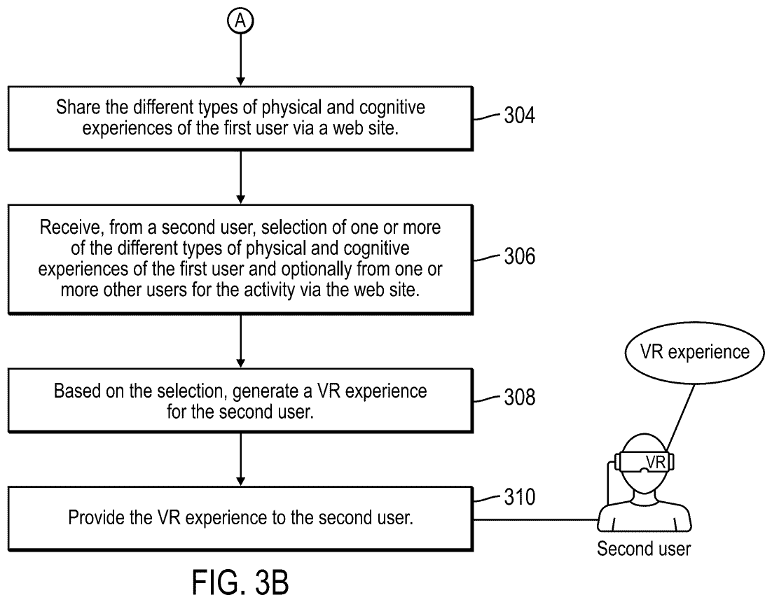

FIGS. 3A and 3B illustrate, in a flowchart, operations for generating a VR experience from an actual experience in accordance with certain embodiments. Control begins at block 300 with the VR system 210 collecting actual experience data while a first user is performing an activity. For example, the first user may perform an outdoor activity, and the actual experience data indicates that the environment is windy with snowflakes. As another example, the first user is riding on an aerial tram, and the actual experience data indicates that there was a sudden jerk on the ropes midway through the ride. As a further example, the first user is riding a rollercoaster, and the environment data indicates that there are vibrations. As yet another example, the first user is wearing wearable devices, and the environment data includes the data from the wearables, such as biometric data of the first user and movement data of the first user.

The VR system 210 collects the actual experience data via feeds from the surroundings of the first user and from the wearable devices of the first user for a period of time while the first user is performing the activity. The VR system 210 also collects the actual experience data by analyzing images, text, and audio (i.e., verbal information) in the feeds.

In block 302, the VR system 210 analyzes the actual experience data in real time for the period of time to identify different types of physical and cognitive experiences of the first user while the first user is performing the activity. For example, the different types of physical and cognitive experiences may indicate that an experience made the first user very scared, mildly scared, excited or happy. In certain embodiments, the VR system 210 collects the actual experience data in periods of time, where each period of time is a range of time set or changed by the first user or by a system administrator. A period of time may be a time scale, which reflects the full duration of an actual experience.

In block 304, the VR system 210 shares the different types of physical and cognitive experiences of the first user via a web site. The web site may be a social networking site.

In block 306, the VR system 210 receives, from a second user, selection of one or more of the different types of physical and cognitive experiences of the first user and optionally from one or more other users for the activity via the web site.

In block 308, the VR system 210, based on the selection, generates a VR experience for the second user. By allowing the second user to select one or more of the different types of physical and cognitive experiences for use in generating the VR experience, the VR system 210 allows the second user to obtain a customized VR experience.

In block 310, the VR system 210 provides the VR experience to the second user. For example, if the second user selected a snowy environment, the VR experience will display a snowy environment. In certain embodiments, providing the VR experience includes sending the VR experience to a VR interface being used by the second user and automatically playing the VR experience.

In certain embodiments, the VR system 210 makes multiple VR experiences for activities performed by different users. Then, the second user may select one of the VR experiences for playing in a VR headset.

Thus, in certain embodiments, while the first user performs an activity, the VR system 210 captures the actual experience data from various IoT and wearable devices, environmental information, and BCI signals. The VR system 210 identifies different types of physical and cognitive experiences from the actual experience data. Then, when sharing the physical and cognitive experiences, the VR system 210 sets access rights. The access rights provide different levels of security, permission, and parental control so that the second user is limited to particular physical and cognitive experiences of the first user. With the access rights set, the VR system 210 may provide particular physical and cognitive experiences to the second user based on those access rights. Then, the second user selects one or more of these physical and cognitive experiences for generation of a VR experience.

In certain embodiments, the VR system 210 is installed on a first user's mobile device, such as a smart phone. In other embodiments, the VR system 210 may be executing on a separate computer or on a cloud node that obtains the actual experience data from the mobile device.

In certain embodiments, while the first user is performing an activity, the VR system 210 on the mobile device of the first user captures the actual experience data. For example, the VR system 210 captures IoT feeds from surrounding information sources and captures data from wearable devices of the first user. In certain embodiments, to capture the IoT feeds from the surrounding information sources, the mobile device receives the published IoT feeds from the surrounding machines, devices or other equipment.

In certain embodiments, the VR system 210 identifies each machine, device, or other equipment providing data with a unique identifier and with a relative position in the physical surroundings.

In certain embodiments, the first user wears different types of wearable devices, and the VR system 210 on the mobile device captures biometric and other information from the wearable devices.

In certain embodiments, the VR system 210 on the mobile device of the first user captures the actual experience data for a time scale. Time scale refers to the mobile device of the first user capturing the actual experience data time stamped for the full duration of the actual experience.

In certain embodiments, based on the sensor feeds gathered from various sources, the VR system 210 on the mobile device classifies the actual experience data as related to the surroundings or related to the user.

In certain embodiments, the VR system 210 analyzes the actual experience data related to the surroundings for types of mechanical simulation and environmental parameters and identifies different types of physical experiences.

In certain embodiments, the VR system 210 analyzes the actual experience data related to the first user (i.e., biometric feedback of the first user) to identify, for example, whether the first user is scared or enjoying the activity. With this, the VR system 210 identifies different types of cognitive experiences.

In certain embodiments, along with capturing the IoT feeds from the surrounding information sources, the VR system 210 identifies whether the first user captures any photographs, video, text messages, emails or verbal messages.

In certain embodiments, the VR system 210 uses a Convolutional Neural Network (CNN) to analyze the photographs, video, text messages, emails or verbal messages to identify a level of experience the first user is having. The CNN is a machine learning model.

In certain embodiments, based on the sensor feeds from the surrounding information sources, the mechanical simulation, the environmental parameters, the biometric feedback, photographs, video, text messages, emails, verbal messages, the VR system 210 identifies the physical and cognitive experiences of the first user.

Once the first user's actual experience is captured, the VR system 210 allows the user to share the actual experience along with activity information. The first user may assign different types of access rights on different portions of the actual experience, including parental controls.

In certain embodiments, the VR system 210 shares the different portions of the actual experience via a social networking site, and enables a second user to select any combination of the different portions of the experience using a VR interface.

In certain embodiments, the second user selects one or more portions from one or more shared actual experiences in the social networking cite, and the VR system 210 generates a VR experience from the selected one or more portions.

While having different types of experiences to be simulated, the VR system 210 identifies what types of simulators are to be used such as haptic gloves or a haptic seat.

The VR system 210 shows the VR experience to the second user. Then, the second user, viewing the activity in the VR environment, has the experience.

In certain embodiments, the VR system 210 identifies what types of experiences are selected by the second user for simulation, and the VR system 210 adapts those experiences into a VR experience.

In certain embodiments, a second user runs a teleoperational view through a remote first user. The VR system 210 begins by selecting a foundational model. The foundational model selection may be based on optimal transport or morphing the foundational model's description and output to a desired description. Latent Semantic Analysis (LSA) morphing may be the foundational model technique. Now, the foundational model is dynamically adapted based on the first user's teleoperational movement. A series of regression models map the laws of motion that determine velocity and displacement into batch and epoch learning parameters.

After a generative network (“generator”) is trained, the VR system 210 applies the generative network to create images. The VR system 210 trains a discriminator and applies a similar technique as the generator.

The image that is passed by the discriminator is sent to a CNN to translate the medium into haptics or any other virtual experience.

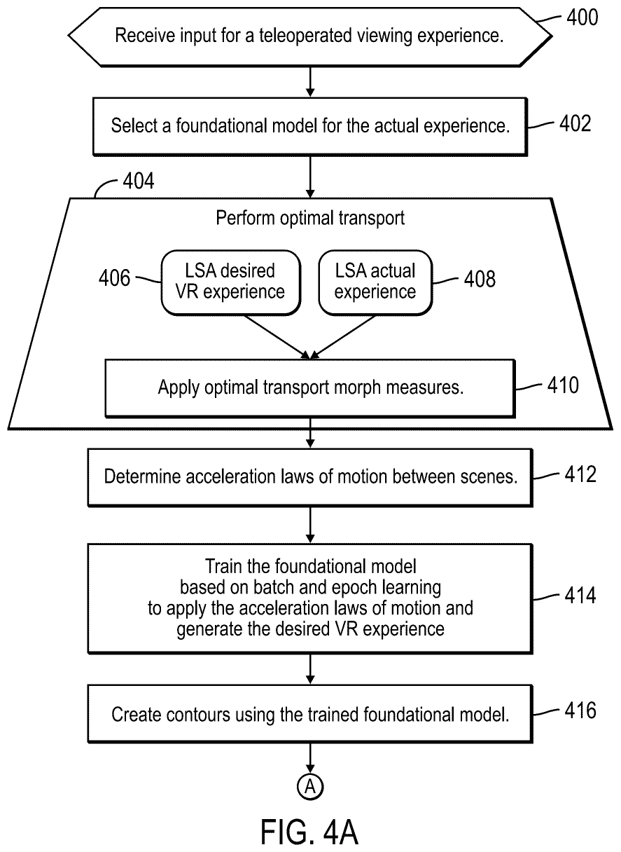

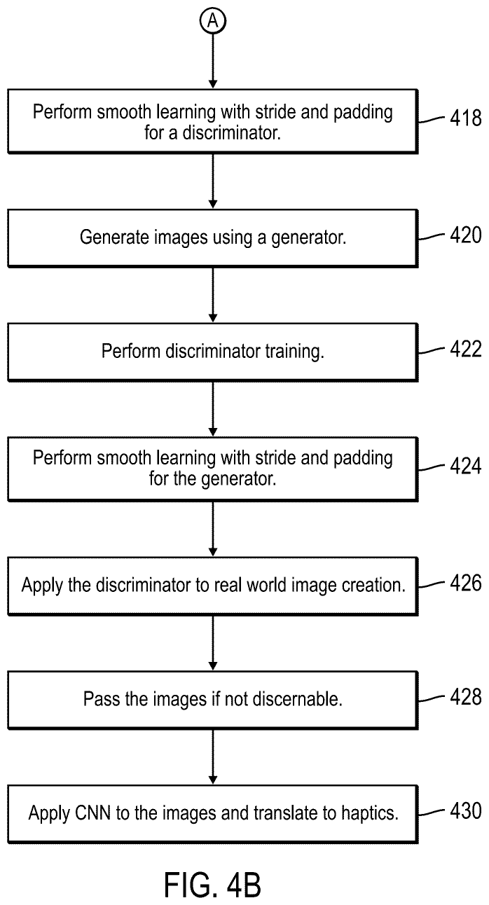

FIGS. 4A and 4B illustrate, in a flowchart, operations for generating a VR experience using machine learning models in accordance with certain embodiments. Control begins at block 400 with the VR system 210 receiving input for a teleoperated viewing experience. In certain embodiments, the input identifies portions of an actual experience, which are physical and cognitive experiences. In certain embodiments, the input identifies portions of one or more actual experiences. In certain embodiments, the input includes parameters for changing the one or more actual experiences. For example, one parameter may change the type of car used in the actual experience, while another parameter may change the acceleration of the car in the actual experience, while yet another parameter may change the weather in the actual experience. The user may be the one who participated in the actual experience or a different user.

In block 402, the VR system 210 selects a foundational model for the actual experience based on the user input. A foundational model may be described as a machine learning model that is trained on a broad set of data to be used as a foundation for generating contours.

In block 404, the VR system 210 performs optimal transport to output a Latent Semantic Analysis (LSA) desired VR experience 406 and an LSA actual experience 408. In block 410, the VR system 210 applies optimal transport morph measures to generate a series of smoothly changing intermediate images between images in the LSA desired VR experience 406 and the LSA actual experience 408.

In block 412, the VR system 210 determines acceleration laws of motion between scenes. For example, if the LSA actual experience represents driving a car at 30 miles per hour, and the LSA desired VR experience represents driving the car at 15 miles per hour, the VR system 210 determines acceleration laws of motion between scenes to adjust the scenes from 30 miles per hour to 15 miles per hour.

In block 414, the VR system 210 trains the foundational model based on batch and epoch learning to apply the acceleration laws of motion and generate the desired VR experience. In machine learning, batch refers to a small subset of the training data used to update a machine learning model's parameters at once, while epoch refers to the entire training dataset. Thus, with epoch training, the machine learning model sees every data point once. That is, the VR system 210 trains the foundational model to adjust speed for the desired VR experience. Adjusting speed may be described as applying acceleration laws of motion between scenes of the actual experience and the desired VR experience.

In block 416, the VR system 210 creates contours using the trained foundational model. In machine learning, contours refer to the outlines or boundaries of objects within an image, essentially defining the edge of a shape or region of interest. Contours are used for object detection and image segmentation by identifying the perimeter of an object within an image. From block 416 (FIG. 4A), processing continues to block 418 (FIG. 4B).

In block 418, the VR system 210 performs smooth learning with stride and padding for a discriminator. In machine learning, smooth learning with stride and padding refers to the technique of adjusting the stride and padding parameters in a layer of a machine learning model to control the spatial resolution of the output features, allowing for a smoother transition between different levels of feature extraction while preserving information at the image borders.

In block 420, the VR system 210 generates images using a generator.

In block 422, the VR system 210 performs discriminator training. The discriminator is a machine learning model that classifies both real data and fake data from the generator, which is another machine learning model. Real data instances may be real pictures of people. The discriminator uses these instances as positive examples during training. Fake data instances are created by the generator. The discriminator uses these instances as negative examples during training.

In block 424, the VR system 210 performs smooth learning with stride and padding for the generator. The generator and discriminator work hand in hand, and the VR system 210 applies the same functions to the generator as were applied to the discriminator in block 418.

In block 426, the VR system 210 applies the discriminator to real world image creation.

In block 428, the VR system 210 passes the images if not discernable. That is, as the generator improves with training, the discriminator performance gets worse because the discriminator can't easily tell the difference between real and fake images.

In block 430, the VR system 210 applies CNN to the images and translates to haptics. CNN is an image processing technique that is used to process the images coming out of the previous block 428 and converts the output image to signals/language that the haptic device will understand. Imagine, if there is an image of a ball coming to the user's hand, the haptic gloves should vibrate, and the VR system 210 determines hen to vibrate the haptic gloves.

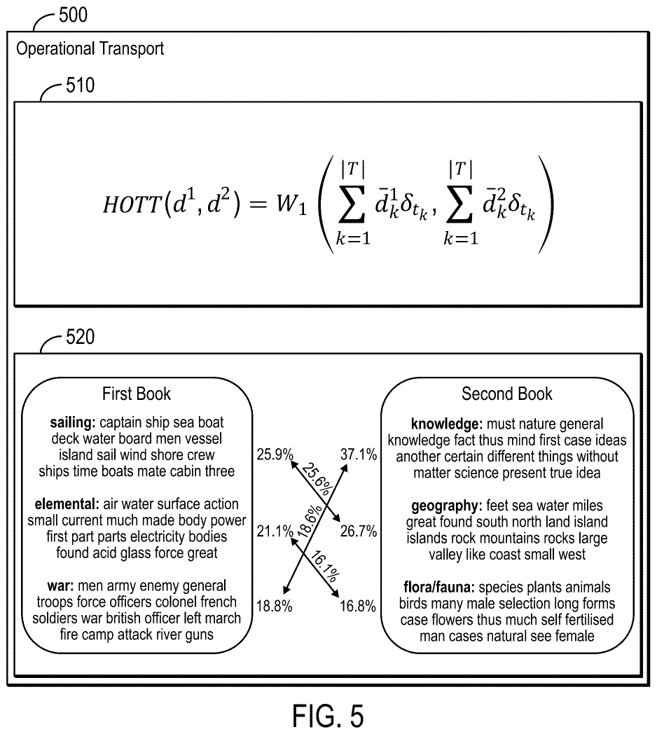

FIG. 5 illustrates further details of operational transport 500 in accordance with certain embodiment. The VR system 210 performs operational transport using Hierarchical Optical Topic Transport (HOTT) 510. Block 520 illustrates how terms from two books are related using operational transport.

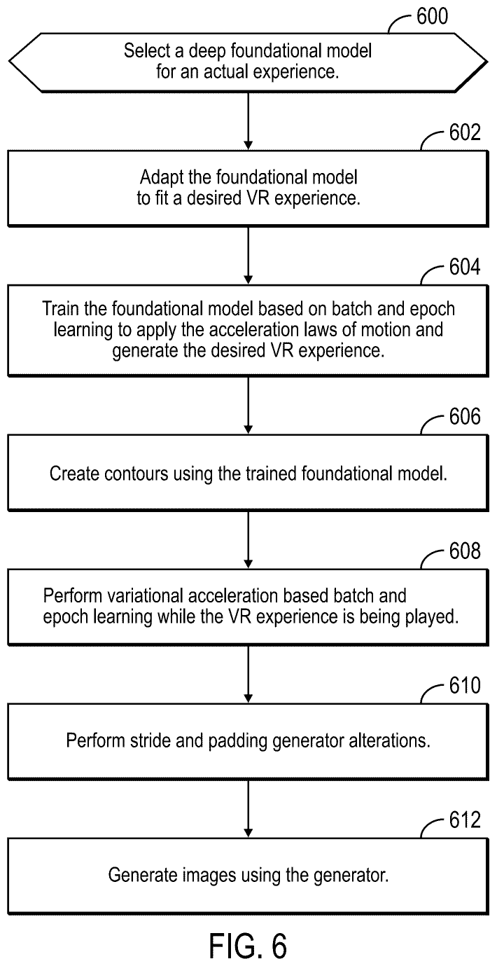

FIG. 6 illustrates, in a flowchart, operations for generating a VR experience using a deep foundational model in accordance with certain embodiments. Control begins at block 600 with the VR system 210 selecting a deep foundational model for an actual experience. The actual experience may be requested by a user.

In block 602, the VR system 210 adapts the foundational model to fit a desired VR experience. This may also be referred to as teleoperating online learning. Adapting the foundational model may include, for example, combining more than one actual experience, modifying one actual experience or providing the same, actual experience.

In block 604, the VR system 210 trains the foundational model based on batch and epoch learning to apply the acceleration laws of motion and generate the desired VR experience using equations 710. That is, the VR system 210 trains the foundational model to adjust speed for the desired VR experience. Adjusting speed may be described as applying acceleration laws of motion between scenes of the actual experience and the desired VR experience. In block 604, the VR system 210 generates the desired VR experience, transitioning from the actual experience to the new, desired VR experience. The operations of block 604 may also be referred to as acceleration based batch and epoch learning using equations 710.

In block 606, the VR system 210 creates contours using the trained foundational model. The contours smooth experiences between the desired VR experience and the actual experience.

In block 608, the VR system 210 further trains the foundational model based on batch and epoch learning to apply the acceleration laws of motion and generate the desired VR experience using equations 720 while the VR experience is being played. In block 608, the VR system 210 is adjusting speed of the desired VR experience while the user is viewing the desired VR experience through a VR headset. That is, the VR system 210 maintains the desired VR experience created in block 604 as the environment and user keeps changing or interacting within the desired VR experience. The operations of block 608 may also be referred to as variational acceleration based batch and epoch learning using equations 720.

In block 610, the VR system 210 performs stride and padding generator alterations. In machine learning, smooth learning with stride and padding refers to the technique of adjusting the stride and padding parameters in a layer of a machine learning model to control the spatial resolution of the output features, allowing for a smoother transition between different levels of feature extraction while preserving information at the image borders.

In block 612, the VR system 210 generates images using the generator. These images form the desired VR experience.

In certain embodiments, once the foundational model is trained in block 604, the VR system 210 uses the foundational model to perform the operations of blocks 606-612 while a user is playing the desired VR experience. This allows the VR system 210 to make changes in real time to the desired VR experience (e.g., if the user changes acceleration).

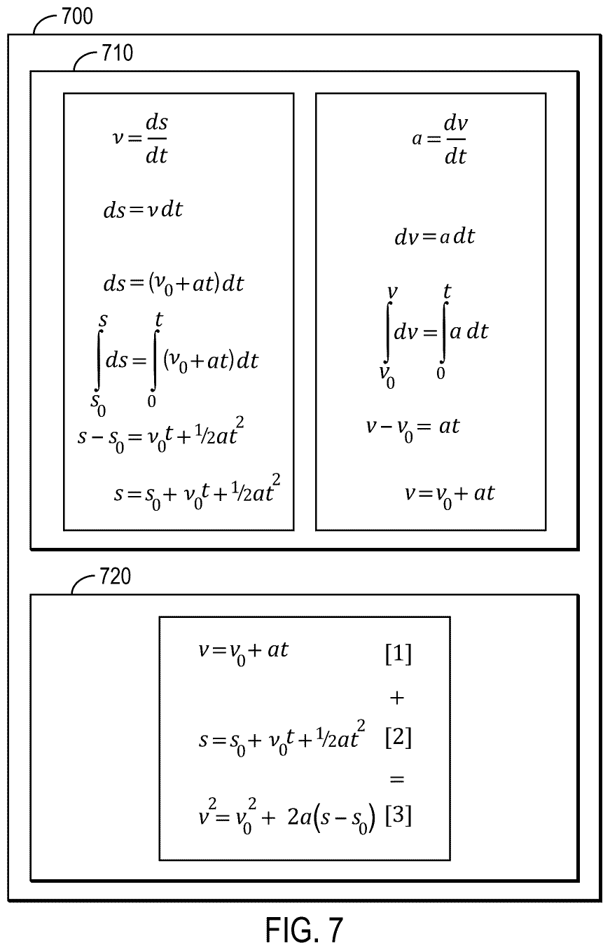

FIG. 7 illustrates equations 700 used for generating the VR experience in accordance with certain embodiments. In particular, the operations of block 604 use equations 710, while the operations of block 608 use equations 720.

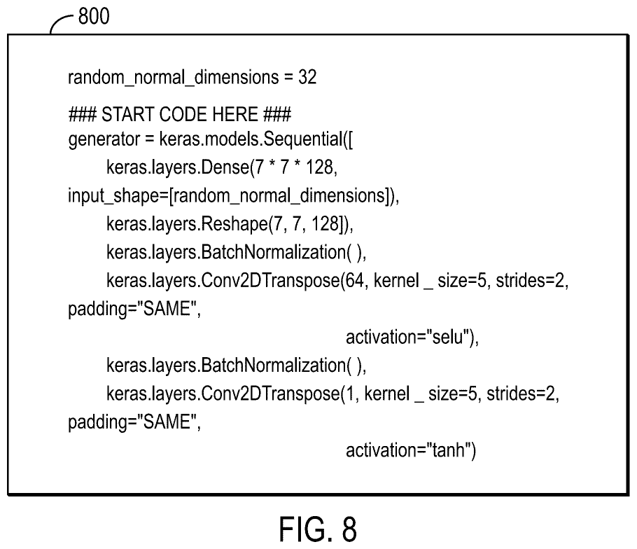

FIG. 8 illustrates pseudocode 800 in accordance with certain embodiments. The pseudocode 800 is the example of a neural network.

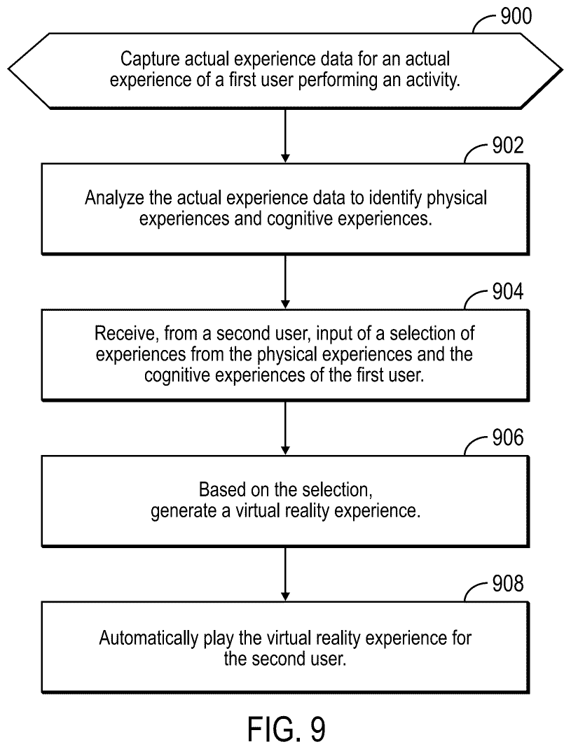

FIG. 9 illustrates, in a flowchart, operations for generating a Virtual Reality (VR) experience from an actual experience and sharing that VR experience in accordance with certain embodiments. Control begins at block 900 with the VR system 210 capturing actual experience data for an actual experience of a first user performing an activity. In block 902, the VR system 210 analyzes the actual experience data to identify physical experiences and cognitive experiences. In block 904, the VR system 210 receives, from a second user, input of a selection of experiences from the physical experiences and the cognitive experiences of the first user. In block 906, the VR system 210, based on the selection, generates a virtual reality experience. In block 908, the VR system 210 automatically plays the virtual reality experience for the second user.

In certain embodiments, the VR system 210 automatically plays the virtual reality experience for the second user by sending the virtual reality experience to a virtual reality interface and automatically playing the virtual reality experience.

In certain embodiments, the VR system 210 assigns access rights to the physical experiences and the cognitive experiences and limits selection of the physical experiences and the cognitive experiences based on the access rights of the second user.

In certain embodiments, the VR system 210 receives, from the second user, a parameter to modify the actual experience and adjusts the virtual reality experience based on the parameter using contouring. In certain embodiments, the parameter modifies one of an acceleration and an environment associated with the actual experience. Parameters that change the environment may change a location (e.g., a beach location to a park location) of the actual experience, may change a vehicle in the actual experience, may change weather in the actual experience, and may change other aspects of the environment. The, the VR system 210 plays the VR experience with any changes.

In certain embodiments, the VR system 210 provides new physical experiences and new cognitive experiences of a plurality of users. The VR system 210 receives, from the second user, a new selection of experiences from the physical experiences and the cognitive experiences of the first user and the new physical experiences and the new cognitive experiences of the plurality of users. The VR system 210, based on the new selection, generates a new virtual reality experience. The VR system 210 plays the new virtual reality experience for the second user.

In certain embodiments, the VR system 210 generates the virtual reality experience using one or more machine learning models.

Thus, in certain embodiments, the VR system 210 records an experience, where the experience is recorded via experiential data that includes environmental data and actor cognitive data. The VR system 210 replicates the experience for a user via a VR simulation.

Embodiments of the VR system 210 are applicable in the teleoperations, telerobotics, and tele-maintenance areas. In certain embodiments, the VR system 210 may be provided as a service type for cloud robotics for teleoperations solutions.

In certain embodiments, by putting robotic arms on mobile platforms and using teleoperation to control them, robots that are mobile may be used in places where they could not be used before. These new mobile applications of robots allow the robots to access areas that are hazardous to humans, while still performing with human-like accuracy. In such cases, the robots may be first users, and the VR system 210 may collect actual experience data from a robot's actual experience to generate a VR experience for a human or another robot.

Robots may be lightweight, compact, portable, power-dense, rugged, and efficient. These robots may be designed to perform tasks as a human would in an array of difficult environments. In such cases, once a human first user has performed a task, the VR system 210 generates a VR experience for use in training the robot. This enables robots to perform tasks once accessible to just humans and be implemented and automated all over the world.

Using AI and machine learning, robots are becoming increasingly autonomous. Robots course correct and learn over time. As robots become more efficient, the VR system 210 is able to capture actual experience data from the robots and generate VR experiences for training human second users for risk assessment/management.

Robots visualize and process the world around them through Light Detection and Ranging (LIDAR), stereo vision, and monocular vision, with sensors for both 2-Dimensional (2D) and 3-Dimensional (3D) imaging. Modern vision systems are able to locate and track a target in nearly any environment, regardless of traffic or weather. In such cases, the robots may be first users, and the VR system 210 may collect actual experience data from a robot's actual experience to generate a VR experience for a human or another robot.

Teleoperation includes communication between a human first user and a robot. The VR system 210 is able to capture the human first user's actual experience data in communicating with the robot and generate a VR experience. Such a VR experience may be used to improve the communications between the human first user and the robot.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
capturing actual experience data for an actual experience of a first user performing an activity;
analyzing the actual experience data to identify physical experiences and cognitive experiences;
receiving, from a second user, input of a selection of experiences from the physical experiences and the cognitive experiences of the first user;
based on the selection, generating a virtual reality experience; and
playing the virtual reality experience for the second user.

2. The computer-implemented method of claim 1, wherein playing the virtual reality experience for the second user comprises sending the virtual reality experience to a virtual reality interface and automatically playing the virtual reality experience.

3. The computer-implemented method of claim 1, wherein the operations further comprise:
assigning access rights to the physical experiences and the cognitive experiences; and
limiting selection of the physical experiences and the cognitive experiences based on the access rights of the second user.

4. The computer-implemented method of claim 1, wherein the operations further comprise:
receiving, from the second user, a parameter to modify the actual experience; and
adjusting the virtual reality experience based on the parameter using contouring.

5. The computer-implemented method of claim 4, wherein the parameter modifies one of an acceleration and an environment associated with the actual experience.

6. The computer-implemented method of claim 1, wherein the operations further comprise:
providing new physical experiences and new cognitive experiences of a plurality of users;
receiving, from the second user, a new selection of experiences from the physical experiences and the cognitive experiences of the first user and the new physical experiences and the new cognitive experiences of the plurality of users;
based on the new selection, generating a new virtual reality experience; and
playing the new virtual reality experience for the second user.

7. The computer-implemented method of claim 1, wherein the virtual reality experience is generated using one or more machine learning models.

8. A computer program product comprising:
one or more computer-readable storage media; and
program instructions stored on the one or more computer-readable storage media to perform operations comprising:
capturing actual experience data for an actual experience of a first user performing an activity;
analyzing the actual experience data to identify physical experiences and cognitive experiences;
receiving, from a second user, input of a selection of experiences from the physical experiences and the cognitive experiences of the first user;
based on the selection, generating a virtual reality experience; and
playing the virtual reality experience for the second user.

9. The computer program product of claim 8, wherein playing the virtual reality experience for the second user comprises sending the virtual reality experience to a virtual reality interface and automatically playing the virtual reality experience.

10. The computer program product of claim 8, wherein the operations further comprise:
assigning access rights to the physical experiences and the cognitive experiences; and
limiting selection of the physical experiences and the cognitive experiences based on the access rights of the second user.

11. The computer program product of claim 8, wherein the operations further comprise:
receiving, from the second user, a parameter to modify the actual experience; and
adjusting the virtual reality experience based on the parameter using contouring.

12. The computer program product of claim 11, wherein the parameter modifies one of an acceleration and an environment associated with the actual experience.

13. The computer program product of claim 8, wherein the operations further comprise:
providing new physical experiences and new cognitive experiences of a plurality of users;
receiving, from the second user, a new selection of experiences from the physical experiences and the cognitive experiences of the first user and the new physical experiences and the new cognitive experiences of the plurality of users;
based on the new selection, generating a new virtual reality experience; and
playing the new virtual reality experience for the second user.

14. The computer program product of claim 8, wherein the virtual reality experience is generated using one or more machine learning models.

15. A computer system comprising:
a processor set;
one or more computer-readable storage media; and
program instructions stored on the one or more computer-readable storage media to cause the processor set to perform operations comprising:
capturing actual experience data for an actual experience of a first user performing an activity;
analyzing the actual experience data to identify physical experiences and cognitive experiences;
receiving, from a second user, input of a selection of experiences from the physical experiences and the cognitive experiences of the first user;
based on the selection, generating a virtual reality experience; and
playing the virtual reality experience for the second user.

16. The computer system of claim 15, wherein playing the virtual reality experience for the second user comprises sending the virtual reality experience to a virtual reality interface and automatically playing the virtual reality experience.

17. The computer system of claim 15, wherein the operations further comprise:
assigning access rights to the physical experiences and the cognitive experiences; and
limiting selection of the physical experiences and the cognitive experiences based on the access rights of the second user.

18. The computer system of claim 15, wherein the operations further comprise:
receiving, from the second user, a parameter to modify the actual experience; and
adjusting the virtual reality experience based on the parameter using contouring.

19. The computer system of claim 18, wherein the parameter modifies one of an acceleration and an environment associated with the actual experience.

20. The computer system of claim 15, wherein the operations further comprise:
providing new physical experiences and new cognitive experiences of a plurality of users;
receiving, from the second user, a new selection of experiences from the physical experiences and the cognitive experiences of the first user and the new physical experiences and the new cognitive experiences of the plurality of users;
based on the new selection, generating a new virtual reality experience; and
playing the new virtual reality experience for the second user.
